(19) United States
(12) Patent Application Publication
(10) Pub. No.: US 2025/0180166 A1
(43) Pub. Date: Jun. 5, 2025

(54) METHOD AND SYSTEM FOR ZERO BOIL-OFF OPERATION IN LIQUEFIED GAS APPLICATIONS

(71) Applicant: CSH2 Corp., Princeton, NJ (US)

(72) Inventors: Pingping MA, Orefield, PA (US); Xianming LI, Orefield, PA (US)

(21) Appl. No.: 19/045,271

(22) Filed: Feb. 4, 2025

Related U.S. Application Data
(63) Continuation of application No. PCT/US2023/027245, filed on Jul. 10, 2023.
(60) Provisional application No. 63/398,296, filed on Aug. 16, 2022.

(51) Int. Cl. F17C 6/00; F17C 9/00

(52) U.S. Cl. CPC F17C 6/00; F17C 9/00; F17C 2205/0134; F17C 2205/0323; F17C 2205/0352; F17C 2221/011; F17C 2221/012; F17C 2221/013; F17C 2221/014; F17C 2221/017; F17C 2221/033; F17C 2223/0161; F17C 2227/0142; F17C 2227/0178

(57) ABSTRACT

A system and a method are disclosed for zero vent loss operation of a liquefied gas application, whereby a transfer pump is used to deliver, through nozzles, controlled size liquid droplets to recondense the vapor in the headspace of a storage tank, thereby reducing the tank pressure and preventing vent loss from either the source tank or the receiving customer tank. The fill process can be automated to use a combination of top fill and bottom fill to achieve a desired receiving tank pressure to ensure long dormancy and minimum or no safety venting. The method and system can apply to liquid hydrogen and other liquefied gases.

### PRIORITY CLAIM AND CROSS-REFERENCE

This application is a continuation of International Application No. PCT/US2023/027245, filed Jul. 10, 2023, which claims the benefit of U.S. Provisional Application No. 63/398,296, filed Aug. 16, 2022, which applications are expressly incorporated by reference herein in their entirety.

### FIELD OF THE INVENTION

The disclosure relates to methods and systems for storing, transferring or dispensing a liquefied gas generally. More particularly, the disclosed subject matter relates to a system and a method for storing and dispensing liquefied gas such as liquid hydrogen or other gases, with vent loss reduction or elimination in a liquefied gas storage vessel.

### BACKGROUND

Tens to hundreds of kilograms of liquid hydrogen (LH₂) is vented during the delivery and refill of a customer storage vessel, also known as a cryotank, by an industrial gas company (IGC) delivery tanker, representing a significant financial loss to the customer and negative impact to the environment. Between the IGC refills, the liquid hydrogen storage tank would discharge for intended operation such as filling fuel cell electric vehicles and stay idle between discharge operations, all the while collecting heat due to static heat leak or dynamic heat leak from discharge operations. The cryotank pressure could rise and eventually would require venting to stay within safe pressure limits. Other liquefied gas applications involving liquid helium, liquid natural gas, liquid oxygen, liquid nitrogen, liquid carbon dioxide, and others generally known as industrial gases face similar challenges, although the economic impact varies depending on the value of the product involved. There is a need to reduce or eliminate such vent losses.

### SUMMARY OF THE INVENTION

Disclosed herein are a system and a method to reduce or eliminate vent losses during IGC fills and the safety venting between fills. Specifically, the use of a transfer pump enables the withdrawal of liquid from the IGC tanker without raising the tanker's headspace pressure, and the use of a special fill device in the customer storage tank to create the desired sized droplets allows controlled headspace vapor condensation to achieve the desired tank pressure during fill. This combination not only eliminates venting during a fill, but also sets up the cryotank for long dormancy, thus reducing or eliminating safety venting before the next IGC fill. In this context, liquefied gas is transferred from the source to the destination. The destination storage vessel is referred to as a customer storage tank, a customer storage cryotank, a customer storage vessel, or the second cryotank. This nomenclature is used to distinguish from the source vessel which could be from an IGC supplier or some other supplier and may also be called the first cryotank. The destination storage vessel may be a fixed storage vessel or a storage vessel on a mobile platform or on a skid for easy installation. The word “tank” or “cryotank” or “vessel” may be used interchangeably.

One aspect of the invention disclosed herein is a system comprising a first cryotank, which is a liquefied gas supply source tank, and a second cryotank, which is a receiving cryotank where a liquefied gas is stored which can be either stationary or on a mobile platform and the first supply tank and the second receiving tank are fluidly connected. The system further comprises a set of valves to control flow disposed therein, a nozzle with single or multiple orifices, or multiple nozzles of the same or different designs disposed in the second receiving vessel, and a transfer pump of high flow and low discharge pressure, which is fluidly connected to the said first supply source tank and the second cryotank through a first control valve and the nozzle to the top of the second receiving cryotank, or through a second control valve to the bottom of the second receiving cryotank, whereby the transfer pump, through the nozzle, generates liquid droplets of millimeter diameter size to recondense the vapor at the second receiving cryotank headspace and decrease the second receiving cryotank pressure, or to the bottom of the second cryotank to increase its pressure, thereby maintaining the second receiving cryotank pressure at a desired level while the second receiving cryotank is being filled with no vent loss.

Another aspect of the invention relates to the liquefied gas comprising liquid hydrogen as well as others generally known as industrial gases such as liquid natural gas, liquid oxygen, liquid nitrogen, liquid carbon dioxide, liquid helium.

Yet another aspect of the invention relates to the nozzle comprising a diffuser with one or multiple orifices, one or more showerheads, or one or more fire sprinkler type devices with a central jet and deflector plate. The nozzle can have a fixed orifice or a variable orifice.

Yet another aspect of the invention relates to the desired droplet size to be in the range of 1 mm to 10 mm, preferably 3 mm to 8 mm, preferably adjustable by varying nozzle pressure.

Yet another aspect of the invention relates to the desired flow rate and pressure of the transfer pump. The desired flow rate is 10 to 300 gallons per minute (0.038 to 1.1 m³/min), preferably 20 to 200 gpm (0.076 to 0.76 m³/min), more preferably 20 to 100 gpm (0.076 to 0.38 m³/min). The desired discharge pressure of 2 to 20 bar_g, preferably 5 to 15 bar_g. The transfer pump comprises preferably a submerged pump inside the receiving customer cryotank, or a submerged pump inside the supply source tanker, or an external pump disposed between the supply source tanker and the receiving customer cryotank. Furthermore, the transfer pump comprises a centrifugal pump, a positive displacement pump, or any suitable design. For clarity, the liquefied gas storage vessel on the IGC delivery vehicle is colloquially known as a tanker in the industry, and the delivery vehicle is also known as a tanker truck, or sometimes simply called a tanker. Whether a tanker refers to a storage vessel or the delivery vehicle with such a storage vessel is clearly understood from the context.

In another aspect, the present disclosure also provides a system for zero boiloff and vent loss of a liquefied gas application. The system is configured to be coupled with a first cryotank, which is a source tank and configured to supply a liquefied gas to the system. The system comprises a second cryotank configured to receive and store the liquefied gas from the first cryotank, a set of valves configured to control flow of the liquefied gas from the first cryotank to the second cryotank, a nozzle with single or multiple orifices, or multiple nozzles of the same or different designs, and a transfer pump of high flow and low discharge pressure. The transfer pump is fluidly connected to the said first cryotank and the second cryotank through a first control valve and the nozzle to the top of the second cryotank, or through a second control valve to the bottom of the second cryotank. The transfer pump is configured to, through the nozzle, generate and send liquid droplets of millimeter diameter size into a headspace of the second cryotank to recondense vapor therein and decrease a pressure of the second cryotank, or to flow liquid to the bottom of the second cryotank to increase its pressure, thereby maintaining the pressure of the second cryotank at a desired level while the second cryotank is being filled with no vent loss.

In another aspect, the present disclosure also provides a method for controlling the pressure inside the second cryotank. Such a method includes using the system as described herein. In some embodiments, such a method comprises steps of supplying a liquefied gas from the first cryotank to the second cryotank, and generating liquid droplets of the liquefied gas having a diameter size of millimeter level using the transfer pump through the nozzle so as to maintain the pressure of the second cryotank at a desired level while the second cryotank is being filled with no vent loss. The liquefied gas and the range of the droplet sizes are described herein.

### BRIEF DESCRIPTION OF THE DRAWINGS

The present disclosure is best understood from the following detailed description when read in conjunction with the accompanying drawings. It is emphasized that, according to common practice, the various features of the drawings are not necessarily to scale. On the contrary, the dimensions of the various features are arbitrarily expanded or reduced for clarity. Like reference numerals denote like features throughout specification and drawings.

FIG. 1 illustrates an exemplary system comprising major components in accordance with some embodiments.

FIG. 2 illustrates one embodiment of a spray nozzle, which is a diffuser type nozzle in accordance with some embodiments.

FIG. 3 illustrates another embodiment of the spray nozzle, similar to an automatic fire sprinkler, using a central jet and a deflector plate, in accordance with some embodiments.

FIG. 4 illustrates another exemplary system in accordance with some embodiments.

FIG. 5 shows two cycles of operation for a typical storage tank using the system and method disclosed herein.

### DETAILED DESCRIPTION

This description of the exemplary embodiments is intended to be read in connection with the accompanying drawings, which are to be considered part of the entire written description. In the description, relative terms such as “lower,” “upper,” “horizontal,” “vertical,”, “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description and do not require that the apparatus be constructed or operated in a particular orientation. Terms concerning attachments, coupling and the like, such as “connected” and “interconnected,” refer to a relationship wherein structures are secured or attached to one another either directly or indirectly through intervening structures, as well as both movable or rigid attachments or relationships, unless expressly described otherwise.

For purposes of the description hereinafter, it is to be understood that the embodiments described below may assume alternative variations and embodiments. It is also to be understood that the specific articles, compositions, and/or processes described herein are exemplary and should not be considered as limiting.

In the present disclosure the singular forms “a,” “an,” and “the” include the plural reference, and reference to a particular numerical value includes at least that particular value, unless the context clearly indicates otherwise. When values are expressed as approximations, by use of the antecedent “about,” it will be understood that the particular value forms another embodiment. As used herein, “about X” (where X is a numerical value) preferably refers to ±10% of the recited value, inclusive. For example, the phrase “about 8” preferably refers to a value of 7.2 to 8.8, inclusive. Where present, all ranges are inclusive and combinable. For example, when a range of “1 to 5” is recited, the recited range should be construed as including ranges “1 to 4”, “1 to 3”, “1-2”, “1-2 & 4-5”, “1-3 & 5”, “2-5”, and the like. In addition, when a list of alternatives is positively provided, such listing can be interpreted to mean that any of the alternatives may be excluded, e.g., by a negative limitation in the claims. For example, when a range of “1 to 5” is recited, the recited range may be construed as including situations whereby any of 1, 2, 3, 4, or 5 are negatively excluded; thus, a recitation of “1 to 5” may be construed as “1 and 3-5, but not 2”, or simply “wherein 2 is not included.” It is intended that any component, element, attribute, or step that is positively recited herein may be explicitly excluded in the claims, whether such components, elements, attributes, or steps are listed as alternatives or whether they are recited in isolation.

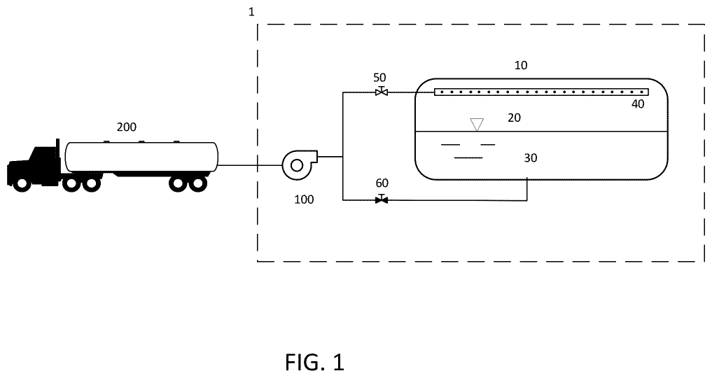

In FIGS. 1-5, like items are indicated by like reference numerals, and for brevity, descriptions of the structure, provided above with reference to FIGS. 1-5, are not repeated.

The methods described herein are described with reference to the exemplary structure described in FIGS. 1-5.

The disclosure relates to methods and systems for storing, transferring or dispensing a liquefied gas. More particularly, the disclosed subject matter relates to a system and a method for storing and dispensing liquefied gas such as liquid hydrogen or other gases, with vent loss reduction or elimination in a liquefied gas storage vessel, especially during the refilling process of such storage vessels by a supply source. The system and the method provided in the present disclosure are applicable to liquid hydrogen, as well as other liquefied gases such as liquid helium, liquid natural gas, liquid oxygen, liquid nitrogen, liquid carbon dioxide, and others generally known as industrial gases.

Liquid hydrogen storage together with a liquid pump has proven to be a low-cost hydrogen dispensing option for hydrogen fuel cell electrical vehicles. Compared to the gaseous hydrogen option, liquid storage has much lower unit cost of storage so that more hydrogen can be stored at the same cost as high-pressure gas. Liquid pumping is up to 10 times more energy efficient than gas compression. Although hydrogen liquefaction is energy intensive, the subsequent savings in transport costs and station dispensing costs along the supply chain outweigh the initial production cost, and liquid hydrogen has become the preferred choice in most of the newly built stations.

However, liquid hydrogen is a deep cryogen, which is stored in vacuum insulated vessels. Even then, the second law of thermodynamics dictates that heat leak into such storage vessels can be minimized but never eliminated. Modern construction methods create vessels with heat leak at approximately 1.0 W/m², which translates into approximately 1% normal evaporation rate (NER) for liquid hydrogen. The NER is defined as the vaporized liquid as a percent of the nominal storage mass per day, the nominal storage mass being the product of the nominal cryogen density and the storage tank volume. A 1% NER for a typical 18,000 gallon (68.1 m³) tank means approximately 45 kg of liquid hydrogen is evaporated each day. As a result, the storage tank pressure would increase, and the boiloff vapor has to be vented through a safety relief valve if not used.

Another source of heat into the storage tank is via the operation of the liquid pump. External pumps return seal leakage, known as blowby, via a return pipe to the cryotank. Internal submerged pumps dissipate heat of friction to the cryotank. Such heat leak from operation is known as dynamic heat leak and can be significant as well. Theoretically, for liquid pumps to support H70 vehicle fueling, hydrogen dispensing energy requirement is approximately 2 kWh/kg dispensed. Even a 5% of this energy returned to the cryotank can cause 0.8 kg liquid to boil off for each kg dispensed, which is significant.

Yet another source of hydrogen loss is during storage tank refill. Tens to hundreds of kilograms of liquid hydrogen (LH₂) could be vented during the delivery and refill of a customer storage vessel by an industrial gas company (IGC) delivery tanker, representing a significant financial loss to the customer and negative impact to the environment. Currently, there is no incentive to reduce such vent loss because all products are paid for by the customer. The typical refill process starts with the IGC driver building the tanker pressure using an onboard pressure-building coil which simply adds heat from the ambient to vaporize a portion of the liquid to raise the tanker headspace pressure. At the same time, the driver would vent down the customer tank. The reason for this process is to set up a pressure difference between the IGC tanker and the customer cryotank for liquid to flow. After the refill, the IGC driver must vent down the tanker before getting back on the road due to road safety requirements. Petitpas (2018) describes the boil-off and vent losses along the LH₂ delivery process. In particular, he describes the need to vent down the IGC delivery tanker headspace pressure before the tanker can get back on the public road according to transport safety requirements.

In addition, Petitpas and Simon (2017) systematically discuss the liquid hydrogen infrastructure and losses along various points. Normal evaporation rate, known as NER in the industry, refers to liquid boiloff in the storage tank due to heat leak from walls and support structures. Vent loss during storage vessel refill is a major component of the total loss. Simon (2016) proposes a method to reduce boiloff in a cryogenic storage vessel by raising its allowable pressure. The content inside such vessels would be under high pressure likely in supercritical state. Such cryo-compressed vessels combine the benefits of cryogenic insulation with a high-pressure storage system, but also inherit their costs together. Ruth (2009) is a comprehensive analysis of both losses and energy use of gaseous and liquid along the hydrogen pathways. Venting and NER are both major items in such conditions.

Other liquefied gas applications involving liquid helium, liquid natural gas, liquid oxygen, liquid nitrogen, liquid carbon dioxide, and others generally known as industrial gases face similar challenges, although the economic impact varies depending on the value of the liquefied gas product involved.

A system and a method are hereby disclosed that eliminate venting due to boiloff by NER and dynamic heat leak, as well as venting during refill. This method is not only applicable for liquid hydrogen refueling stations but also any application involving a liquid hydrogen storage tank that needs to be periodically refilled by an IGC tanker. As depicted in FIG. 1, a transfer pump 100 is disposed in the fill connection between the customer cryotank 10 and the IGC tanker 200. This transfer pump is capable of high flow but only moderate pressure head is required. For example, a pump with 10 bar discharge pressure and a flow rate of 200 gallons per minute (0.76 m³/min) is adequate. This transfer pump would withdraw liquid from the IGC tanker 200 and deliver it to the customer cryotank 10 without first establishing a pressure difference between the source and the target, thus venting from the customer tank as well as the IGC tanker as described earlier for a typical IGC refill is eliminated. Next, the transfer pump delivers the liquid to a special nozzle 40 at the top of the headspace 20 in the customer cryotank 10. The nozzle mimics a showerhead with liquid droplets to contact the vapor in the headspace. Heat and mass transfer between the vapor and the liquid droplets would condense the vapor. This re-condensation phenomenon is confirmed in the industry by decreasing headspace pressure, sometimes so much so that it causes vapor pressure to collapse. The difference here is that this vapor condensation process is controlled to allow zero boiloff during refill and during the subsequent operation until the next refill.

An alternative embodiment would place the transfer pump 100 inside the IGC tanker 200 or inside the customer tank 10 in a submerged configuration. A submerged configuration keeps the pump cold all the time without frequent thermal cycling which is the cause of pump maintenance and failures. Keeping the pump always cold also eliminates any cooldown requirement and the associated delay during a fill. Submerged pump operation has been proven in LH₂, LNG, CO₂, and other liquefied gas operations.

The system 1 designated in FIG. 1 by dotted line is for illustration purposes only and represents only one possible grouping of the key components. Other standard components such as manual valves, automatic valves, safety relief valves, vent stacks, piping, instrumentation required to safely receive liquefied gas, store it and use it are omitted for clarity. These components and subsystems within the dotted line are fixed on a customer location or on a mobile platform. The delivery tanker 200 is clearly a different, mobile asset. These two groupings may or may not have different ownership. One exception to the delineation is the transfer pump 100. As disclosed above, the transfer pump 100 could be a submerged pump inside the IGC delivery tanker 200 which would be outside the current dotted line designation.

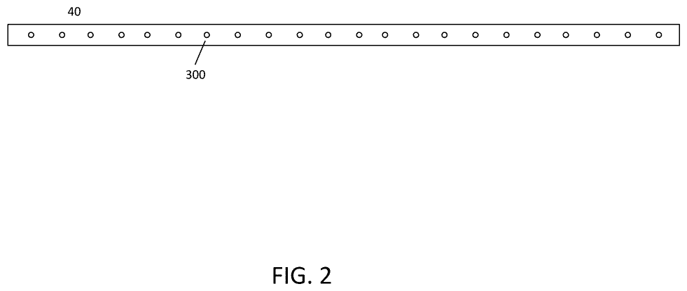

One embodiment of nozzle 40 consists of a header and a number of orifices 300 as described in FIG. 2. Good engineering design principles (Tilton, 2008) for uniform flow distribution would call for orifice pressure drop to be at least 10 times the pressure drop along the header, thus the ratio of header pipe cross sectional area to the sum of all orifice openings should be at least the square root of 10, or roughly 3 times. The size of the orifice controls the size of the droplets which impact heat and transfer, thus vapor recondensation. The smaller the droplet size, the faster mass transfer and more recondensation. Yet if the droplets are too small, they heat up quickly by the potentially superheated vapor in the headspace and start to evaporate, thereby increasing the headspace pressure. In addition to droplet size, vapor recondensation in the headspace also depends on droplet flight time. That is, the time between a droplet emerging from the nozzle and the moment it hits the liquid surface. An emptier cryotank would allow longer droplet flight time thus more mass transfer. Headspace vapor is likely superheated to various degrees depending on cryotank heat leak rate, thus even if the liquid from the IGC tanker is nominally at the same saturation temperature as the liquid in the customer cryotank, condensation of headspace vapor still occurs. The optimum droplet size to balance vapor recondensation and droplet evaporation is approximately a few millimeters in diameter. Until now, no attempt in assessing droplet size impact has been documented by the liquefied gas industry.

More specifically, Teng et al. (1995) describes droplet size in relations to fluid, geometry, and flow parameters mainly in low orifice Reynolds number and low droplet Weber number conditions. On the other hand, Kooij et al. (2018) measured liquid droplets into air with various nozzle and fluid parameters and found that the volume mean diameter d₅₀ scales well with Weber number and density ratio in high-Weber number flows where inertia dominates surface tension, relevant to the liquid hydrogen application at hand:

$${d}_{50} \sim {d ( \frac{{ρ}_{liq}}{{ρ}_{v}} )}^{\frac{1}{6}} {We}^{- \frac{1}{3}} ; We = \frac{{ρ}_{liq} {v}^{2} d}{σ} ;$$

since

$${ρ}_{liq} {v}^{2} \sim Δ p , {d}_{50} \sim {( \frac{{d}^{2} σ}{Δ p} )}^{\frac{1}{3}} {( \frac{{ρ}_{liq}}{{ρ}_{v}} )}^{\frac{1}{6}}$$

Altenratively, since

$$Q = Av \sim {d}^{2} \sqrt{Δ p / {ρ}_{liq}} , Δ p \sim {( \frac{Q}{{d}^{2}} {ρ}_{liq} )}^{2} ,$$

so that

$${d}_{50} \sim {{d}^{2} ( \frac{σ}{{Q}^{2} {ρ}_{liq}^{2}} )}^{\frac{1}{3}} {( \frac{{ρ}_{liq}}{{ρ}_{v}} )}^{\frac{1}{6}}$$

Here, d is the nozzle orifice diameter, σ is the surface tension of the liquid, Q is volumetric flow rate, A is cross sectional flow area of the liquid, v is droplet velocity which is initially the same as that of the liquid exiting the nozzle orifice, Δp is nozzle pressure drop, ρ_{liq} and ρᵥ are liquid and vapor densities, respectively. Weber number, We, is a measure of inertia relative to surface tension effects. These relationships indicate that droplet size as characterized by the volume mean diameter d₅₀ increases with nozzle orifice diameter and surface tension but decreases with nozzle pressure or nozzle volumetric flow rate. Unless explicitly indicated otherwise, the term “droplet size” used in this disclosure refers to the volume mean diameter.

Because liquid hydrogen surface tension at the normal boiling point is approximately 40 times smaller than water at the ambient conditions (0.00118 vs. 0.052 N/m), it is quite difficult to make large droplets of several mm in diameter. Using the formulas in Kooij et al (2018), the volume mean diameter of droplets from an orifice of 5 mm diameter is computed for several liquids for illustration purposes and shown in Table 1. Assume nozzle pressure drop is 2 bar, and the storage tank pressure is 2 bar_g except for carbon dioxide at 8 bar_g. Further, assume that the liquid is saturated at the liquid delivery pressure (tank pressure plus nozzle pressure drop) and the vapor is saturated at the tank pressure. Although water would generate droplets, on average, at 0.46 mm, liquid hydrogen droplets would be only 72 microns, more than 6 times smaller. Liquefied natural gas as represented by methane, liquid nitrogen and liquid carbon dioxide would have droplet sizes in between water and liquid hydrogen. It is clear that a traditional nozzle with a single circular orifice is inappropriate for creating the desired size droplets.

TABLE 1
Droplet size evaluation for various liquids starting from an orifice of 5 mm diameter.

| Fluid | | H₂ | H₂O | Methane | N₂ | CO₂ |
|---|---|---|---|---|---|---|
| Orifice diameter, d | mm | 5 | 5 | 5 | 5 | 5 |
| Nozzle pressure drop | bar | 2 | 2 | 2 | 2 | 2 |
| Cryotank pressure | barg | 2 | 2 | 2 | 2 | 8 |
| Saturated liquid density | kg/m³ | 60.8 | 915.2 | 384.9 | 723.6 | 1106.4 |
| Saturated vapor density | kg/m³ | 3.66 | 1.66 | 4.97 | 12.7 | 23.5 |
| Velocity, ν = | m/s | 73.0 | 18.8 | 29.0 | 21.2 | 17.1 |
| C_{d} \sqrt{2Δp/p} | | | | | | |
| Surface tension | N/m | 0.00118 | 0.05217 | 0.01001 | 0.00655 | 0.01333 |
| Weber number, We = | | 533,971 | 12,026 | 62,674 | 95,850 | 47,053 |
| ρₗν²b/σ | | | | | | |
| Volume mean diameter, | mm | 0.072 | 0.460 | 0.191 | 0.158 | 0.194 |
| d₅₀ | | | | | | |
| | microns | 72 | 460 | 191 | 158 | 194 |
| Nozzle volumetric flow | gpm | 22.7 | 5.9 | 9.0 | 6.6 | 5.3 |
| rate | | | | | | |

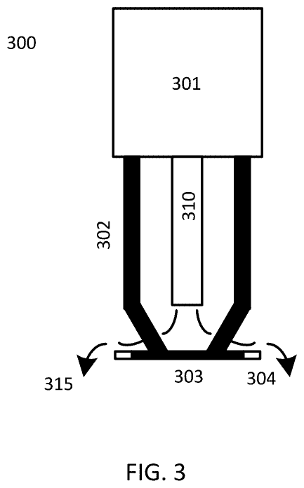

In addition to the diffuser as shown in FIG. 2, a showerhead design is simply multiple orifices clustered together rather than distributed linearly on a header. Yet another embodiment would be a nozzle similar to an automatic fire sprinkler, as shown in FIG. 3. In this design, a nozzle 300 consists of a body 301, support members 302 and a deflector plate 303 with slotted tabs 304. The support members 302 create an open space similar to a cage. At one end of the cage is the nozzle body 301. At the other end of the cage is the deflector plate 303. A large liquid jet 310 emerges from the nozzle body 301 and hits the slotted deflector plate 303. The tabs 304 on the slotted deflector shear the liquid film into many sub-streams 315 which subsequently break up into droplets due to shear with the surrounding gas. Since a single large liquid jet can have high flow yet low pressure, this design is a good choice to generate large liquid hydrogen droplets. Nozzle pressure can be varied by reducing flow rate, changing nozzle orifice size, or selectively activating the number of nozzles. Specifically, for fixed geometry nozzles, reducing flow would decrease nozzle pressure thus increase droplet size. Alternatively, the nozzle can have a variable opening like a camera shutter, or an opening with a movable insert whereby adjusting the insert position affects the flow passage size and nozzle pressure. Furthermore, multiple nozzles can be used to adjust nozzle pressure at a given flow rate where each nozzle has independent flow control means so that some or all of the nozzles are selectively throttled or activated.

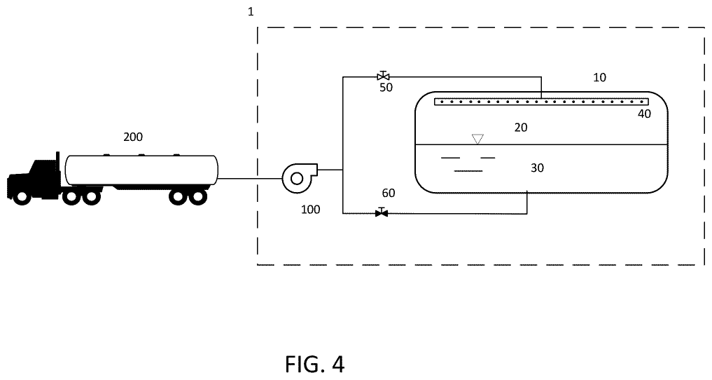

Those skilled in the art would recognize there are alternative ways to place nozzle 40 in the headspace 20 shown in FIG. 1. One such alternative embodiment is shown in FIG. 4 where the supply tube downstream of valve 50 comes at a position substantially at the center of the nozzle, instead of at one end. Yet another embodiment is to use one or more nozzles similar to that shown in FIG. 3 instead of a pipe-type diffuser.

When the droplets are sufficiently small, fast mass transfer from vapor to the droplets results in significant vapor condensation and a decrease in headspace pressure. When the headspace pressure decreases below a threshold, liquid fill should be switched from top fill to bottom fill. This switch occurs when the bottom fill valve 60 is open, and the top fill valve 50 is closed. Because the bottom fill does not cause vapor condensation, liquid level rise in the customer cryotank would increase the headspace pressure. When the headspace pressure reaches another threshold, the fill process can be switched to top fill again. Using a combination of top fill and bottom fill, the tank pressure can be maintained at a desired level while the cryotank is being filled.

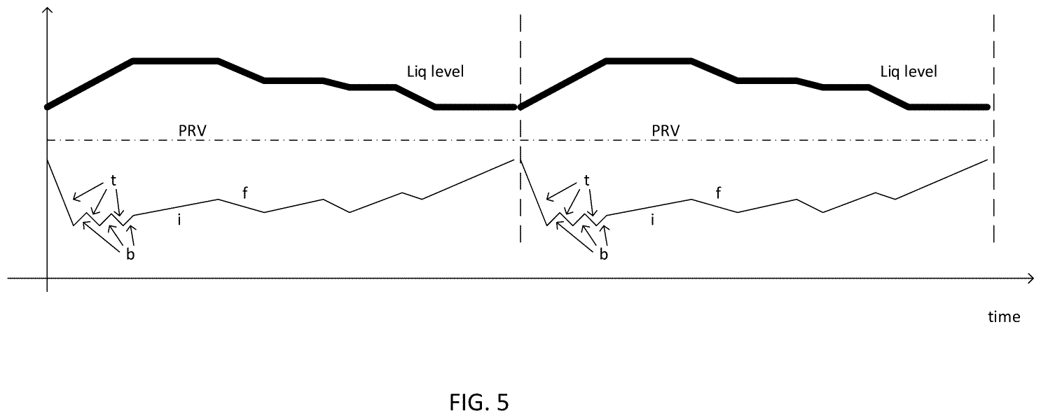

An example of the “fill and use” cycles in a typical customer cryotank is shown in FIG. 5. The horizontal axis is time, the vertical axis is liquid level (the thick black line) and cryotank pressure (the thin black line). Both the horizontal and vertical axes have arbitrary scales. Two cycles were illustrated. At the start of a cycle, the customer tank is empty and the IGC tanker initiates a refill, as shown by the thick blank line for liquid level. During the fill process with the help of a transfer pump 100, a top fill (“t”) is initiated which reduces the cryotank headspace pressure while the liquid level increases. When the cryotank pressure decreases to a threshold, a bottom fill (“b”) starts which increases the headspace pressure. This top-and-bottom fill process repeats until the tank is full while the cryotank pressure is kept at a desired level. A period of idling (“i”) follows when the liquid level is substantially the same but the cryotank pressure increases due to NER. A period of active fueling (“f”) reduces the liquid level and the headspace pressure. Such use-and-idle steps repeat until the liquid level in the cryotank drops to a minimum when an IGC refill is required, and the cycle starts again. A typical IGC fill takes several hours, while each fill-and-use cycle could last several days depending on the customer consumption rate. Thus, the horizontal time axis is not to scale—the fill process is stretched for clarity. Between the IGC fills, although the cryotank pressure progressively increases due to NER and dynamic heat input from fueling operation, the cryotank pressure never reaches the safety pressure relief valve (“PRV”) setting, thus no venting is needed to control cryotank pressure. Since there is no need to vent down the cryotank during the IGC refill, the operation has zero boiloff loss.

A transfer pump has been used in prior art. It is also known in the industry that a top fill can decrease headspace pressure (e.g., Hall et al. 2005). But the system provided in the present disclosure provides controlled droplet size together with a transfer pump to achieve zero boiloff loss for the first time in a nonobvious manner. Furthermore, it is unexpected that, unlike typical spray technology where fine droplets are desired, the liquid hydrogen droplet size must be sufficiently large to be effective. Liquefied gas such as liquid hydrogen has low surface tension, so tends to form very fine mists or droplets. For the application described herein, a relatively large size of droplets in a range is desired. For example, a desirable range may be from about 1 mm to about 10 mm, preferably from about 3 mm to about 8 mm.

The state of the art of a top fill nozzle is simply a pipe opening, approximately 1.25-to-1.5-inch (32 mm to 38 mm) nominal size, although schematically nozzles might have been shown (e.g., Hall et al. 2005). Its placement is also haphazard. As a result, the benefit of vapor recondensation is not purposefully exploited, only accidentally observed. In fact, when the headspace pressure decreases, it is considered a nuisance which is quickly remedied by switching to bottom fill. The transfer pump is likely an external pump which requires cooldown before each use. That cooldown process causes boiloff loss and delay in the fill process. Worse yet, thermal cycling leads to frequent maintenance and short pump life. IGCs experimented with such external transfer pumps but eventually gave up because the trouble is more than its worth, especially when the customer is paying for all the vent loss anyway.

### EXAMPLES

Detailed heat and mass transfer analysis on droplets and then on cryotank in various cryotank operation modes was carried out. In a top fill, liquid is introduced at or near the top of the cryotank headspace apex. For a given liquid level and cryotank condition, droplet size, and droplet initial condition (IGC tanker condition), output parameters such as droplet flow paths, heat transfer and mass transfer are evaluated. For a droplet that is colder than the surrounding vapor, it emerges from the nozzle, heats up by the surrounding vapor, condenses some of the vapor, increases its diameter by both mass addition and density change due to heat transfer. This evolving droplet decelerates due to drag and buoyancy, but accelerates due to gravity, as it falls through the vapor. The heat, mass, and momentum transfer processes continue until the droplet either hits the liquid pool or completely evaporates. For a droplet that is warmer than the vapor, evaporation would occur, and its flight path would be short. For any droplet, both vapor condensation and droplet evaporation can occur. In fact, condensation followed by evaporation can occur in the same droplet flow path as it is being heated by the vapor. The heat and mass transfer results on the droplet scale are then used for heat and material balance on the cryotank scale, assuming all droplets behave similarly. The fill process progresses until the desired level is reached or the cryotank pressure is too high or too low. Cryotank tank pressure can be too high and reach the pressure relief valve (PRV) setting due to evaporation with fine droplets, very warm vapor, warm IGC liquid, short droplet flight time due to high liquid level, and other factors. At opposite conditions, cryotank pressure can be too low when condensation occurs very rapidly. During the top fill process, heat leak from NER and heat input from a transfer pump are also considered.

In a bottom fill, the fill pipe opening sits near the bottom of the cryotank with a flow deflector, also known as a “witch's hat”, a short distance downstream of the opening to divert flow sideways instead of forming a jet possibly breaking through the free surface of the liquid pool. No droplet condensation or evaporation occurs. The headspace pressure increases due to decreasing vapor volume, as well as heat input from NER and the transfer pump.

During discharge, dynamic heat leak from pumping operation to discharge from the cryotank is represented as a fraction of discharge energy usage in kWh/kg. In addition, heat input from NER is always present.

During idle, the cryotank receives heat due to NER which evaporates some liquid and increases the vapor mass. NER also directly heats up the vapor to increase headspace pressure. Liquid pool temperature also slowly increases due to direct absorption of heat from NER. For long idle duration, the vapor near the apex of the headspace can be significantly superheated due to stratification, reaching near or even above 200 K locally and into hydrogen embrittlement regime for the inner tank material. For this reason, if pressure relief is required, the relief line opening should be at or near the apex point of the cryotank so that the superheated vapor is preferentially vented first.

These analyses are now integrated to simulate a typical cryotank operation. A customer cryotank of 18,000 gallons (68.1 m³) with 1% NER starts a refill from an IGC tanker when its liquid level is 30%. The transfer pump produces a flow rate of 100 gallons per minute (gpm, 0.38 m³/min). Assume the customer cryotank is at 11 bar_g at the end of the “fill-and-use” cycle, which corresponds to a saturation temperature of 32.6 K and the remaining liquid in the cryotank is saturated at 32.6 K. Finally, an average of 10K superheat is assumed in the headspace. These cryotank conditions with high pressure, saturated liquid and superheated vapor represent a very severe condition known in the industry as “old liquid.” Further, assume the IGC tanker is at 30 psig (2.1 bar_g) with a saturated liquid temperature of 24.8 K and a liquid density of 65 kg/m³. Again, this is an undesirable IGC delivery condition with warm liquid because a fresh load would have liquid temperature close to 21 K. If the droplet size is 7 mm uniformly, 35,000 droplets would form every second ideally. In reality, a liquid jet from a nozzle breaks up to a distribution of droplet sizes whose volume mean diameter d₅₀ is related to orifice size, fluid viscosity and surface tension (see Teng et al 1995 and Kooij et al. 2018). That means there are as many droplets smaller than this diameter as there are droplets larger than this diameter. The overall heat and mass transfer based on the mean diameter represents the average behavior of the real condition. After 90 minutes of top fill, the customer cryotank would be filled to 80%, the total fill is approximately 2200 kg, the headspace pressure would drop from 11 bar_g in the beginning to 5.1 bar_g, and the liquid temperature would decrease from 32 K to 28.4 K, and if the PRV is set at 175 psig (12.1 bar_g), the dormancy time is close to 14 hours. There is no venting during this fill process. If the cryotank conditions are less severe and/or the IGC tanker liquid is colder, a combination of top fill and bottom fill may be required to maintain customer tank pressure at a desired level, and the dormancy time would be much longer.

This example (Ex 1), plus 6 others (Ex 2 through Ex 7) with varying conditions are shown in Table 2. In all examples, the cryotank geometry remains the same: 18,000 gallon volume, 90 inch inner vessel diameter. The fill flow rate is also constant at 100 gallons per minute.

In Example 2 (Ex 2), the cryotank conditions are not as severe: the cryotank initial pressure is at 5 bar_g, the vapor temperature is at 30K, the liquid temperature is at 27K, and the IGC liquid is colder at 22 K. Then after 90 minutes of top fill, the tank level reaches 80%, and the tank pressure drops to 2.8 bar_g. The vapor temperature ends at 26K, and the dormancy is 19.5 hours.

Examples 3 through 6 (Ex 3 through Ex 6) show the impact of droplet size. Going from 7 mm droplet size in Ex 2 to 5 mm, about 10 kg extra vapor is condensed, the final cryotank pressure drops further to 1.7 bar_g, the final vapor temperature decreases to 24.4K, and dormancy increases to 22.7 hours. Further decreasing droplet size to 4 mm (Ex 4) and 3 mm (Ex 5) continues this trend, but going too far in droplet size to 1 mm (Ex 6) causes evaporation of the rapidly heated droplets, and the fill process stops after only 6 minutes because the cryotank pressure has reached close to the pressure relief valve setting. Obviously, there is no dormancy to speak of.

Example 7 (Ex 7) shows the impact of higher NER with other conditions identical to Ex 5. As expected, the final cryotank pressure is slightly higher: 1.1 vs. 1.0 bar_g, and the dormancy is cut in half from 25.3 hours to 12.6 hours. That is, NER primarily affects dormancy but not the fill process, as the fill process is relatively short.

TABLE 2
Examples of top fill with varying conditions.

| Description | Units | Ex. 1 | Ex. 2 | Ex. 3 | Ex. 4 | Ex. 5 | Ex. 6 | Ex. 7 |
|---|---|---|---|---|---|---|---|---|
| Drop size | mm | 7 | 7 | 5 | 4 | 3 | 1 | 3 |
| Liquid level start | | 30% | 30% | 30% | 30% | 30% | 30% | 30% |
| Initial tank pressure | barg | 11 | 5 | 5 | 5 | 5 | 5 | 5 |
| Temperature of IGC liquid | K | 24.8 | 22 | 22 | 22 | 22 | 22 | 22 |
| Initial vapor temperature in tank | K | 43 | 30 | 30 | 30 | 30 | 30 | 30 |
| Initial liquid temperature in tank | K | 32 | 27 | 27 | 27 | 27 | 27 | 27 |
| NER (normal evaporation rate) | %/d | 1% | 1% | 1% | 1% | 1% | 1% | 2% |
| Transfer pump? (1 = yes) | | 1 | 1 | 1 | 1 | 1 | 1 | 1 |
| Vapor condensed | kg | 351.9 | 270.5 | 280.8 | 283.4 | 285.8 | −140.2 | 288.0 |
| Condensation as fraction of total | | 15.8% | 11.5% | 11.9% | 12.0% | 12.1% | −89.8% | 12.2% |
| fill | | | | | | | | |
| Final liquid temperature in tank | K | 28.4 | 25.8 | 24.2 | 23.5 | 23.0 | 22.9 | 23.1 |
| Final pressure in tank | barg | 5.1 | 2.8 | 1.7 | 1.3 | 1.0 | 11.7 | 1.1 |
| total operation time | min | 90.2 | 90.2 | 90.2 | 90.2 | 90.2 | 6.0 | 90.2 |
| final liquid level | | 80% | 80% | 80% | 80% | 80% | 34% | 80% |
| Final vapor temperature | K | 28.4 | 26.0 | 24.4 | 23.5 | 23.0 | 39.9 | 23.2 |
| Dormancy | hrs | 13.9 | 19.5 | 22.7 | 24.1 | 25.3 | -0.1 | 12.6 |

Starting at Ex 1 (Experimental Sample No. 1) conditions but with NER at 2%, further assume the usage rate of the customer cryotank is 1000 kg/day, the average dispensing energy requirement is 2 kWh/kg, and 5% of that dispensing energy is returned to the cryotank as frictional loss, then by the end of the fill-and-use cycle after 2.3 days, the cryotank pressure would be 6.3 bar_g. Note that this pressure is lower than the 11 bar_g assumed at the start of the cycle in Ex 1, allowing further margin for tank pressure buildup due to IGC delivery delays or other unforeseen events. If the pressure relief valve setting is 175 psig (12 bar_g), no venting is ever needed to control cryotank pressure.

The daily usage rate has a major impact on zero boiloff operation. Smaller usage rates prolong the fill-and-use cycle between IGC refills, thus more heat leak enters the load of liquid in the cryotank between refills due to NER. As a result, the cryotank pressure may rise above PRV setting and venting would become necessary. In the above example Ex 1, if the daily use rate is changed to 200 kg/day while all other parameters remain the same, 11.5 days would elapse between refills, and the cryotank pressure would build up to 12 bar_g, necessitating venting. This result is not surprising because a liquid tank would eventually over-pressure if no liquid is used. It also points out why the liquid hydrogen pathway is being adopted for newly built, larger refueling stations. Older, smaller refueling stations in the range of 100 to 200 kg/day have mostly followed the compressed gas pathway.

If daily usage rate is large, there is adequate margin for cryotank pressure rise for different levels of dynamic heat leak and NER. For example, if the usage rate is 1000 kg/day but the dispensing energy consumption is 3 kWh/kg and the frictional loss is 10%, the cryotank pressure would build up to 10.7 bar_g at the next refill, still below the 12 bar_g PRV setting. For a system with a liquid hydrogen pump, such dynamic heat leak rate is the upper limit. The best-in-class system would see dispensing energy consumption at less than 0.5 kWh/kg, frictional loss of 3%, and customer cryotank NER at 1%, then the cryotank pressure would rise to only 1.4 bar_g from 1.0 bar_g at the end of the IGC refill.

The IGC fill process can be automated as follows. Referring to FIG. 1, the fill process starts with a top fill with valve 50 open and valve 60 closed. A customer cryotank pressure signal is used to determine when to switch to a bottom fill to maintain a desired cryotank pressure. Thus, if the cryotank pressure is below a threshold P1, valve 60 opens and valve 50 closes. When the cryotank pressure reaches another threshold P2 where P2 is greater than P1, valve 50 opens and valve 60 closes and a top fill is reinitiated. This process is repeated until the cryotank is filled to the desired level. Further, another pressure signal for the IGC tanker headspace pressure may be used to operate its pressure builder circuit if the tanker pressure falls below a limit Pa, and to stop pressure builder operation when the tanker pressure reaches another limit Pb, where Pb is larger than Pa.

In some embodiments, the systems provided in the present disclosure may further comprise one or more control units or a central unit (not shown in FIGS. 1-5) for controlling the steps of the method and the amount of the liquefied gas in each step or going through each component. The control unit(s) may be electronically connected with the related components in the system. The control unit may comprise one or more processors and at least one tangible, non-transitory machine readable medium encoded with one or more programs to be executed by the one or more processors. The control unit is configured to coordinate with each component so as to control the operation for selecting top fill and bottom fills, discharging liquid to refuel fuel cell electric vehicles, monitoring safety, and so on.

The methods and system described herein may be at least partially embodied in the form of computer-implemented processes and apparatus for practicing those processes. The disclosed methods may also be at least partially embodied in the form of tangible, non-transient machine-readable storage media encoded with computer program code. The media may include, for example, RAMs, ROMs, CD-ROMs, DVD-ROMs, BD-ROMs, hard disk drives, flash memories, or any other non-transient machine-readable storage medium, or any combination of these mediums, wherein, when the computer program code is loaded into and executed by a computer, the computer becomes an apparatus for practicing the method. The methods may also be at least partially embodied in the form of a computer into which computer program code is loaded and/or executed, such that the computer becomes an apparatus for practicing the methods. When implemented on a general-purpose processor, the computer program code segments configure the processor to create specific logic circuits. The methods may alternatively be at least partially embodied in a digital signal processor formed of application specific integrated circuits for performing the methods.

The second cryotank can be a stationary tank for storing liquefied gas such as liquid hydrogen, or a mobile tank such as a tank in a vehicle, for example, a fuel cell vehicle using hydrogen.

The references described herein and listed below are incorporated herein by reference:

G. Petitpas, “Boil-off losses along LH2 pathway,” Technical Report LLNL-TR-750685, Lawrence Livermore National Laboratories, May 2, 2018.

G. Petitpas and A. J. Simon, “Liquid hydrogen infrastructure analysis,” Report LLNL-PRES-727907, DOE project PD135, US DOE Hydrogen and Fuel Annual Merit Review, Jun. 6, 2017.

A. J. Simon, “Cryo-compressed pathway analysis,” Report LLNL-PRES-686398, DOE project PD134, US DOE Hydrogen and Fuel Annual Merit Review, Jun. 9, 2016.

Mark Ruth, “Hydrogen pathways: cost, well-to-wheels energy use, and emissions for the current technology status of seven hydrogen production, delivery and distribution scenarios,” National Renewable Energy Laboratory, Mlissa Laffen and Thomas A. Timbario, Alliance Technical Services, Inc. Technical Report NREL/TP-6A1-46612, September 2009.

J. N. Tilton, “Fluid and particle dynamics,” Perrys Chemical Engineers' Handbook, 8^{th} Edition, 2008, page 6-34.

H. Teng, C. M. Kinoshita, and S. M. Masutani, “Prediction of droplet size from the breakup of cylindrical liquid jets,” International Journal of Multiphase Flow 21, 129-136 (1995).

Kooij, S; Sijs, R; Denn, M.M; Villermaux, E; Bonn, D., “What Determines the Drop Size in Sprays?” Physical Review. X, 2018, Vol 3, p. 031019. DOI: 10.1103/PhysRevX.8.031019.

Hall, I.K, Gish, J.C. and Palframan, K., “Cryogenic vessel with an ullage space venturi assembly,” U.S. Pat. No. 6,904,758 B2, Jun. 14, 2005.

Although the subject matter has been described in terms of exemplary embodiments, it is not limited thereto. Rather, the appended claims should be construed broadly, to include other variants and embodiments, which may be made by those skilled in the art.

What is claimed is:

1. A system for zero boiloff and vent loss of a liquefied gas application, comprising
a first cryotank as a source tank configured to supply a liquefied gas;
a second cryotank configured to receive and store the liquefied gas from the first cryotank;
a set of valves configured to control flow of the liquefied gas from the first cryotank to the second cryotank;
a nozzle with single or multiple orifices, or multiple nozzles of the same or different designs;
a transfer pump of high flow and low discharge pressure, fluidly connected to the said first cryotank and the second cryotank through a first control valve and the nozzle to the top of the second cryotank, or through a second control valve to the bottom of the second cryotank,
whereby the transfer pump is configured to, through the nozzle, generate and send liquid droplets of millimeter diameter size into a headspace of the second cryotank to recondense vapor therein and decrease a pressure of the second cryotank, or to flow liquid to the bottom of the second cryotank to increase its pressure, thereby maintaining the pressure of the second cryotank at a desired level while the second cryotank is being filled with no vent loss.

2. The system of claim 1, wherein the liquefied gas comprises liquid hydrogen, liquid natural gas, liquid oxygen, liquid nitrogen, liquid carbon dioxide, or liquid helium.

3. The system of claim 1, wherein the nozzle comprises a diffuser with a pipe having single or multiple orifices placed substantially uniformly along the pipe to cover substantially a length of the cryotank; one or more showerheads; and/or one or more sprinkler type devices with a central jet and a deflector plate.

4. The system of claim 1, wherein the nozzle comprises a fixed geometry nozzle, and a variable orifice nozzle.

5. The system of claim 1, wherein the droplet size as characterized by a mean value is in the range of from 1 mm to 10 mm.

6. The system of claim 5, wherein the droplet size as characterized by a mean value is in the range of from 3 mm to 8 mm.

7. The system of claim 5, wherein the droplet size as characterized by a mean value is adjustable by varying nozzle pressure.

8. The system of claim 1, wherein the transfer pump has a desired flow rate from 10 to 300gallons per minute (0.038 to 1.1 m³/min), preferably 20 to 200 gpm (0.076 to 0.76 m³/min), more preferably 20 to 100 gpm (0.076 to 0.38 m³/min).

9. The system of claim 8, wherein the transfer pump has a desired flow rate of from 20 to 200 gpm (0.076 to 0.76 m³/min).

10. The system of claim 8, wherein the transfer pump has a desired flow rate of from 20 to 100 gpm (0.076 to 0.38 m³/min).

11. The system of claim 1, wherein the transfer pump has a desired discharge pressure of from 2 to 20 bar_g.

12. The system of claim 1, wherein the transfer pump has a desired discharge pressure of from 5 to 15 bar_g.

13. The system of claim 1, wherein the transfer pump comprises a submerged pump inside the first cryotank, a submerged pump inside the second cryotank, and an external pump disposed between the first cryotank and the second cryotank.

14. The system of claim 1, wherein the transfer pump comprises a centrifugal pump, a positive displacement pump, or any suitable design.

15. A method of using the system of claim 1, comprising:
supplying a liquefied gas from the first cryotank to the second cryotank; and
generating liquid droplets of the liquefied gas having a diameter size of millimeter level using the transfer pump through the nozzle so as to maintain the pressure of the second cryotank at a desired level while the second cryotank is being filled with no vent loss.

16. A system for zero boiloff and vent loss of a liquefied gas application, wherein the system is configured to be coupled with a first cryotank, the first cryotank as a source tank configured to supply a liquefied gas to the system, the system comprising:
a second cryotank configured to receive and store the liquefied gas from the first cryotank;
a set of valves configured to control flow of the liquefied gas from the first cryotank to the second cryotank;
a nozzle with single or multiple orifices, or multiple nozzles of the same or different designs;
a transfer pump of high flow and low discharge pressure, fluidly connected to the said first cryotank and the second cryotank through a first control valve and the nozzle to the top of the second cryotank, or through a second control valve to the bottom of the second cryotank,
whereby the transfer pump is configured to, through the nozzle, generate and send liquid droplets of millimeter diameter size into a headspace of the second cryotank to recondense vapor therein and decrease a pressure of the second cryotank, or to flow liquid to the bottom of the second cryotank to increase its pressure, thereby maintaining the pressure of the second cryotank at a desired level while the second cryotank is being filled with no vent loss.

17. The system of claim 16, wherein the liquefied gas comprises liquid hydrogen, liquid natural gas, liquid oxygen, liquid nitrogen, liquid carbon dioxide, or liquid helium.

18. The system of claim 16, wherein the nozzle comprises a diffuser with a pipe having single or multiple orifices placed substantially uniformly along the pipe to cover substantially a length of the cryotank; one or more showerheads; and/or one or more sprinkler type devices with a central jet and a deflector plate.

19. The system of claim 16, wherein the nozzle comprises a fixed geometry nozzle, and a variable orifice nozzle.

20. The system of claim 16, wherein the droplet size as characterized by a mean value is in the range of from 1 mm to 10 mm.
